(19) United States
(12) Patent Application Publication
(10) Pub. No.: US 2019/0163538 A1
(43) Pub. Date: May 30, 2019

(54) PERFORMANCE TUNING OF VIRTUAL RESOURCES

(71) Applicant: Amazon Technologies, Inc., Reno, NV (US)

(72) Inventors: Matthew D. Klein, Seattle, WA (US); Michael David Marr, Monroe, WA (US); Samuel J. McKelvie, Seattle, WA (US)

(21) Appl. No.: 16/263,485

(22) Filed: Jan. 31, 2019

Related U.S. Application Data
(62) Division of application No. 13/566,788, filed on Aug. 3, 2012.

(51) Int. Cl. G06F 9/50; G06F 9/455; G06F 9/48

(52) U.S. Cl. CPC G06F 9/5077; G06F 9/505; G06F 2009/4557; G06F 9/45558; G06F 9/4881; G06F 9/5083

(57) ABSTRACT

A set of techniques is described for enabling a user of a virtual resource to specify to the hosting system a preferred performance parameter such as throughput, latency, CPU utilization, or the like. The hosting system then dynamically tunes the underlying resources to favor the preferred performance parameter. Tuning the settings may include adjusting various batching and moderating processes that are available on the hosting device, such as enabling/disabling interrupt coalescing, enabling/disabling segmentation offload, increasing or decreasing the size of a ring buffer used to share data between several resources, batching input/output (I/O) operations and the like. For example, if the user has indicated that lower latency is preferable, the hosting system may disable interrupt coalescing; whereas if the user has indicated that higher throughput should be favored, the hosting system may enable interrupt coalescing.

### CROSS-REFERENCE TO RELATED APPLICATIONS

The present application is a divisional of, and claims priority to, U.S. application Ser. No. 13/566,788, entitled “PERFORMANCE TUNING OF VIRTUAL RESOURCES”, filed Aug. 3, 2012, which is incorporated herein by reference for all purposes.

### BACKGROUND

As an increasing number of applications and services are being made available over networks such as the Internet, an increasing number of content, application, and/or service providers are turning to technologies such as cloud computing. Cloud computing, in general, is an approach to providing access to electronic resources through services, such as Web services, where the hardware and/or software used to support those services is dynamically scalable to meet the needs of the services at any given time. A user or customer typically will rent, lease, or otherwise pay for access to resources through the cloud, and thus does not have to purchase and maintain the hardware and/or software needed.

In this context, many cloud computing providers utilize virtualization to allow multiple users to share the underlying hardware and/or software resources. Virtualization can allow computing servers, storage device or other resources to be partitioned into multiple isolated instances that are associated with (e.g. owned by) a particular user. This can enable various users to run their applications remotely on the resources of the cloud computing provider. However, virtual network stacks typically have more layers than physical networking stacks and all of the controls that a user would have on a bare-metal solution may not be available in a virtual solution and/or may not map in the same way in terms of the performance changes they cause. For example, some of the hardware level controls that a user could potentially modify on a physical network may not be exposed to users via a Virtual Interface (VIF). This may cause a virtual network stack to be more difficult to optimize than its physical counterpart.

### BRIEF DESCRIPTION OF THE DRAWINGS

Various embodiments in accordance with the present disclosure will be described with reference to the drawings, in which:

FIG. 1 illustrates an example of a virtualized environment running on a stack of resources, in accordance with various embodiments;

FIG. 2 illustrates an example of the virtualized environment being utilized by a service provider to enable a shared resource environment for a plurality of clients, in accordance with various embodiments;

FIG. 3 illustrates an example of a resource stack whose settings can be tuned by a user, in accordance with various embodiments;

FIG. 4 is an illustration of an environment where a user is enabled to create virtual networks with optimized connections in accordance with various embodiments;

FIG. 5 illustrates an example process for dynamic tuning of virtual resources, in accordance with various embodiments;

FIG. 6 illustrates an example process for dynamically tuning the settings of the virtual resource stack based on gathered runtime information, in accordance with various embodiments;

FIG. 7 illustrates an example process for dynamically tuning the resource stack based at least in part on the execution metrics reported by a user, in accordance with various embodiments;

FIG. 8 illustrates an example process for creating a virtual network with connections between virtual nodes that are optimized for a preferred performance parameter, in accordance with various embodiments;

FIG. 9 illustrates a logical arrangement of a set of general components of an example computing device that can be utilized in accordance with various embodiments; and

FIG. 10 illustrates an example of an environment for implementing aspects in accordance with various embodiments.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Systems and methods in accordance with various embodiments of the present disclosure may overcome one or more of the foregoing or other deficiencies experienced in conventional approaches for tuning and adjusting performance settings in a virtualized computing environment. In particular, various embodiments provide approaches for enabling users of virtual computing resources to specifically tune the resources for desired latency, throughput, and/or CPU utilization, among other such operational parameters.

In various embodiments, a user can submit a request to a service provider (e.g. “cloud computing” provider) for virtual resources that will be used to execute an application on behalf of the user. In response to the request, the service provider (e.g. hosting system) may provision for the user one or more virtual machine instances (or compute nodes) on at least one host computing device. These virtual machine instances can take the form of a guest operating system (e.g. user's selected operating system) running on a physical server of the service provider. The virtual machine instance can run one or more workloads (e.g. applications) on behalf of the user to provide any number of various services.

In accordance with an embodiment, a user of the virtual resource can specify (e.g. via an API) to the hosting system a performance parameter that may be useful to the user, such as throughput, latency, CPU utilization, or the like. The hosting system may then dynamically tune underlying resources (e.g. NIC, SSD, etc.) to favor the preferred performance parameter. In various embodiments, tuning the settings may include adjusting various batching and moderating processes that are available on the resource stack, such as enabling/disabling interrupt coalescing, enabling/disabling segmentation offload, increasing or decreasing the size of a ring buffer used to share data between several resources, batching input/output (I/O) operations and the like. For example, if the user has indicated that lower latency is preferable, the hosting system may disable interrupt coalescing; whereas if the user has indicated that higher throughput should be favored, the hosting system may enable interrupt coalescing. Similarly, if the user wants to keep CPU0 free for as much application processing as possible, the hosting system may dynamically move interrupts away from CPU0.

As used throughout this disclosure, interrupt coalescing is just one example of many hardware or software settings that may be adjusted to achieve different performance effects in computing systems, and described in detail for illustrative purposes. Those of ordinary skill in the art will appreciate that the systems and methods described herein apply to a variety of other hardware and software settings across a variety of computing devices, peripherals components and the like. In addition, interrupt coalescing itself can refer to the batching of interrupts from a variety of devices, although herein examples focus primarily on applications related to the Network Interface Card (NIC).

In this example, when the NIC receives a network packet, it may either immediately send an interrupt signal to the operating system (OS) kernel indicating to it that the packet is ready for processing, or the NIC may choose to wait until a particular number of packets have been received before sending the interrupt. The enabling of interrupt coalescing causes the NIC to wait until a number of packets have been received (or time period expires) before sending the interrupt and similarly, the disabling of the interrupt coalescing causes the NIC to immediately send the interrupt without batching. In many cases, enabling interrupt coalescing can increase the overall throughput of packets and lower the CPU burden related to interrupt servicing since fewer interrupts are sent to the CPU. However, this may be at the expense of incurring higher latency for an individual packet, since packets arriving early in the coalescing segment may need to wait for additional packets to arrive. Similarly, disabling interrupt coalescing may decrease latency per packet; however, this may potentially be at the expense of decreased overall throughput and increased CPU utilization.

As used throughout this disclosure, segmentation offloading (e.g. TCP segmentation offload, large segment offload, etc.) refers to various techniques for increasing throughput of a network connection by queuing up large buffers and splitting the buffers into separate packets. For example, if segmentation offload is enabled, the CPU may hand over a large chunk of data to the NIC, and the NIC may perform the splitting of the large chunk into multiple segments before sending it over the network. As such, enabling segmentation offloading may reduce the CPU requirements related to NIC servicing and increase packet throughput.

It should be noted, however, interrupt coalescing, segmentation offloading and other techniques mentioned throughout this disclosure are used purely as examples of the various settings that may be tuned and that the various embodiments described herein are not limited to these particular examples. Various other settings may be utilized within the scope of the present disclosure, as will be evident to one of ordinary skill in the art.

In at least some embodiments, the system can dynamically optimize the settings for the resources based on the runtime information associated with the user's application running on the virtual resources. For example, the system can perform network packet inspection and/or connection tracking in the virtualization service layer (e.g. the “trusted domain” or Dom-0) and make dynamic decisions to improve the application's performance. As an illustration, if the hosting platform determines that the user's application is performing mostly request/response communication, the hosting platform can tune the settings of the underlying resource stack to favor low latency processing, for example by disabling interrupt coalescing. Similarly, if the hosting system determines that the user's application is performing mostly streaming communication, the system can tune the underlying resources to favor throughput, for example by enabling interrupt coalescing and favoring routes with large Path Maximum Transmission Unit (PMTU). As can be seen in the latter example, several settings or other choices may be adjusted in concert to achieve desired performance goals.

In another embodiment, the system can provide an API (or other service) that allows a user to perform comparisons of various configuration settings. For example, the user can indicate to the system when the virtual machine instance has started executing the workload (e.g. running an application). Once the indication is received, the system can begin to gather runtime information produced by the execution of the workload. For example, the system can start connection tracking, deep packed inspection and the like. After a period of time, the user can then indicate that the virtual machine instance has stopped processing the workload. At that point, the user may change the configuration settings and once again invoke the API to instruct the system to collect runtime metrics for a period of time with the modified settings. All of the collected data can subsequently be compared to determine the optimal settings for the virtual machine. It should be noted that these runtime metrics may be gathered from both the host executing the workload and from other devices, such as network switches or storage systems, that may be involved in providing services not directly available on the server hosting the virtual machine instance.

In at least some embodiments, the system can tune the performance settings for connections between two or more virtual machines provisioned on multiple host computing devices. In particular, the system can provision a virtual network (e.g. virtual private network (VPN)) where the user is enabled to create one or more low latency subnets, high throughput subnets and the like. For example, a user may wish to create a database cluster subnet with low latency connections between the virtual machine nodes of the subnet. The user may then create a second database cluster subnet and then replicate the data between the two subnets over a connection tuned for high throughput. In one embodiment, the system may obtain the topology information about the virtual network from the user and also obtain information indicating which connections between which nodes of the virtual network should be optimized for low latency, high throughput, or high/low CPU utilization. Alternatively, the system may automatically determine the optimal connection settings for the virtual network based on analysis of various data, such as runtime metrics, connectivity requirements, firewall information and the like. In one embodiment, the system may then use one or more placement algorithms to provision the virtual machine nodes onto host computing devices that are tuned for the appropriate performance parameters (e.g. low latency, high throughput, etc.). In various embodiments, the system can place the virtual machines of multiple users that are tuned for the same performance parameters on the same physical host servers since the resources of those host servers are tuned to favor the appropriate performance factors.

As can be seen in the previous example, choices made by the system are not limited to changes in settings on individual computing devices, but may involve broader choices about the physical or logical placement of the virtualized resources which may impact the performance of customer workloads or other goals. In this case, systems that are logically closer together within the network (e.g., connected to the same Top of Rack (TOR) switch) will naturally experience lower latency and less contention for shared network resources. However, servers with a higher degree of physical or logical sharing (e.g., collocation in the same rack, using the same TOR) may also experience statistically higher likelihood of correlated failure if the shared resource fails (e.g. rack loses power). Therefore, configuration choices may impact multiple goals; in this case, favoring lower jitter and latency networking may result in reduced availability or durability for the workload due to higher likelihood of correlated failure among servers providing workload processing.

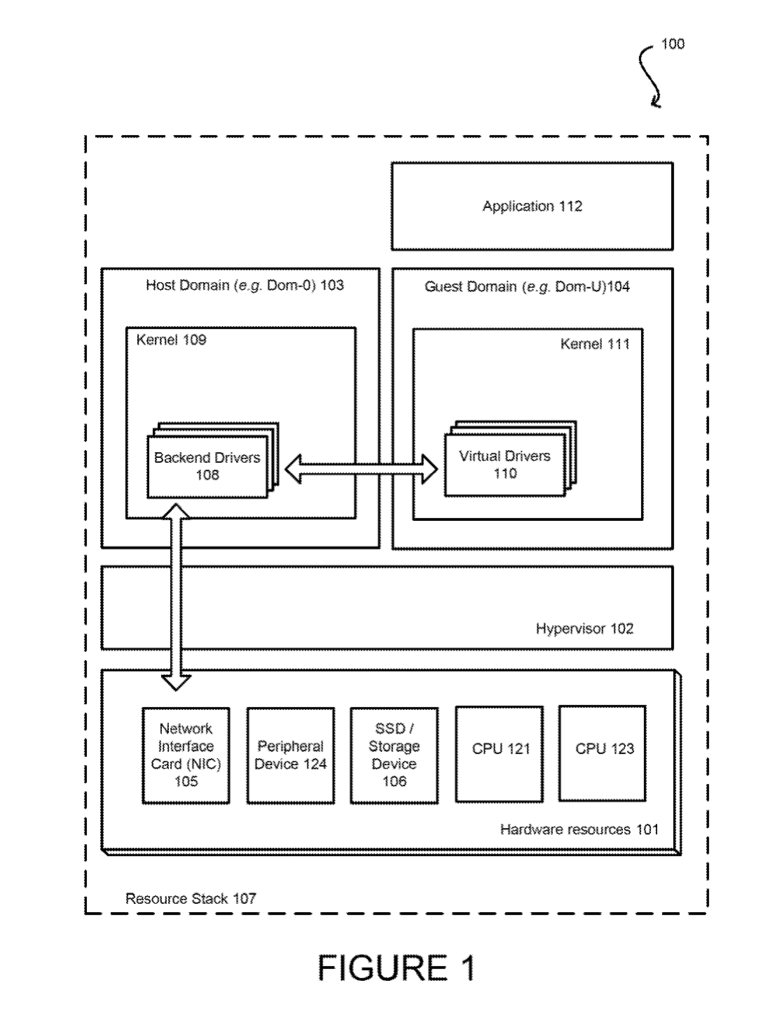

FIG. 1 illustrates an example of a virtualized environment 100 running on a stack of resources, in accordance with various embodiments.

In accordance with the illustrated embodiment, the resource stack 107 includes a number of hardware resources 101, such as one or more central processing units (CPUs) 121, 123; solid state drives (SSD) or other storage devices 106; network interface card (NIC) 105, peripheral devices (e.g. graphics processing unit (GPU), etc.) and the like. In some embodiments, the hardware resources 101 reside on a single computing device (e.g. chassis). In other embodiments, the hardware resources can reside on multiple devices, racks, chassis and the like. Running on top of the hardware resources 101, the virtual resource stack 107 further includes a hypervisor 102, a host domain 103 and one or more guest domains 104 capable of executing at least one application 112. The hypervisor 102 manages the execution of the one or more guest operating systems and allows multiple instances of different operating systems to share the underlying hardware resources 101. Conventionally, hypervisors are installed on server hardware, with the function of running guest operating systems, where the guest operating systems themselves act as servers.

In accordance with an embodiment, the hypervisor 102 can host a number of domains (e.g. virtual machines), such as the host domain 103 and one or more guest domains 104. In one embodiment, the host domain 103 (e.g. Dom-0) is the first domain created and helps virtualize hardware resources 101 and manage all of the other domains running on the hypervisor 102. For example, the host domain 103 can manage the creating, destroying, migrating, saving, or restoring the one or more guest domains 104 (e.g. Dom-U). In accordance with various embodiments, the hypervisor 102 controls access to the hardware resources such as the CPU, input/output (I/O) memory and hypervisor memory.

In accordance with the illustrated embodiment, the guest domain 103 includes one or more virtualized or paravirtualized drivers 110 and the host domain includes one or more backend device drivers 108. When the operating system (OS) kernel 111 in the guest domain 104 wants to invoke an I/O operation, the virtualized driver 110 may perform the operation by way of communicating with the backend device driver 108 in the host domain 103. When the guest driver 110 wants to initiate an I/O operation (e.g. sending out a network packet), a guest kernel component will identify which physical memory buffer contains the packet (or other data) and the guest driver 110 will either copy the memory buffer to a temporary storage location in the kernel for performing I/O or obtain a set of pointers to the memory pages that contain the packet(s). In at least one embodiment, these locations or pointers are provided to the backend driver 108 of the host kernel 109 which can obtain access to the data and communicate it directly to the hardware device, such as the NIC 105 for sending the packet over the network.

It should be noted that the resource stack 107 illustrated in FIG. 1 is only one possible example of a set of resources that is capable of providing a virtualized computing environment and that the various embodiments described herein are not necessarily limited to this particular resource stack. In some embodiments, the guest domain may have substantially native or “bare metal” access to the NIC 105 hardware, for example as provided by device assignment technology based on an IO Memory Management Unit (IO-MMU) device mapping solution like Intel VT-D. Other technologies, such Single Root IO Virtualization (SR-IOV), may provide similar “bare metal” functionality to guest domains for only certain functionality of the devices. In general, in various other embodiments, the resource stack may comprise different virtualization strategies, hardware devices, operating systems, kernels, domains, drivers, hypervisors and other resources.

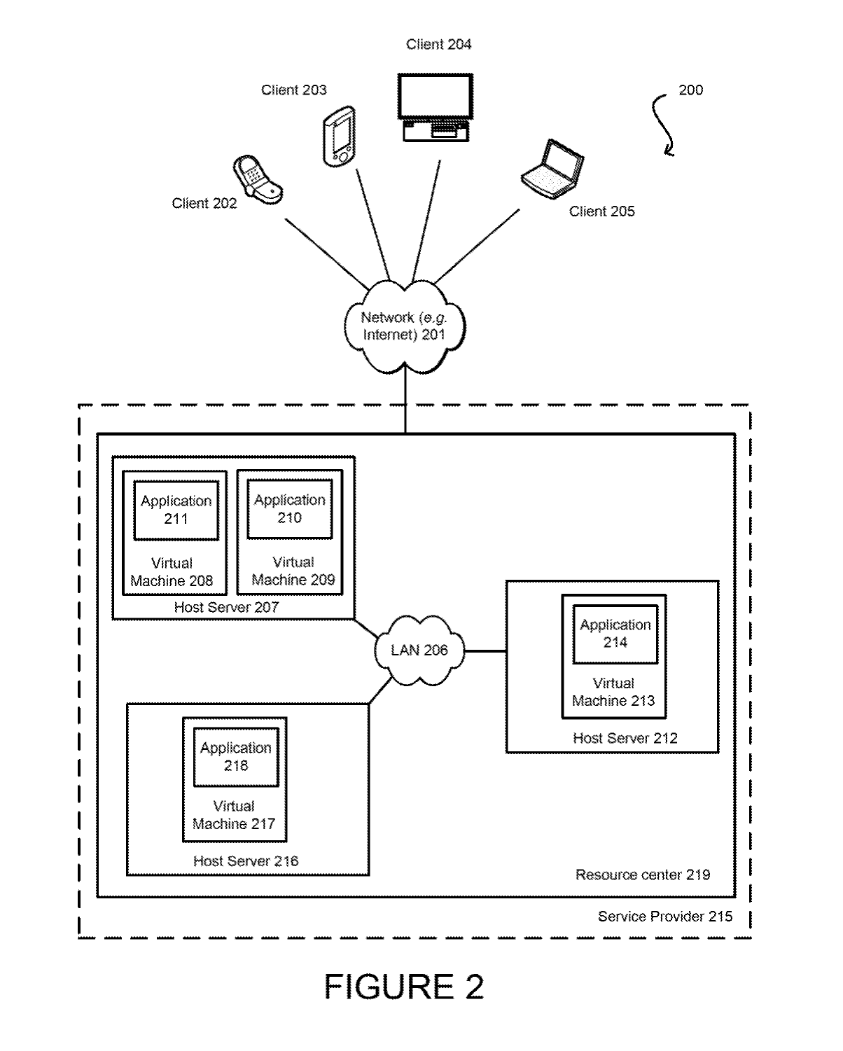

FIG. 2 illustrates an example of the virtual environment 200 being utilized by a service provider to enable a shared resource environment for a plurality of clients, in accordance with various embodiments.

In accordance with the illustrated embodiment, the service provider 215 provides a set of network-accessible services (e.g. Web Services) to one or more clients (202, 203, 204, 205) over a network 201. In this example, the service provider 215 includes a resource center that contains a plurality of resources, such as host servers (207, 212, 216). As used throughout this disclosure, a network can be any wired or wireless network of devices that are capable of communicating with each other, including but not limited to the Internet or other Wide Area Networks (WANs), cellular networks, Local Area Networks (LANs), Storage Area Networks (SANs), Intranets, Extranets, and the like. The resource center 219 can include any physical or logical grouping of resources, such as a data center, a server farm, content delivery network (CDN) point-of-presence (POP) and the like. The resource center of the service provider may include various computer servers, data storage machines, network devices and other hardware resources necessary to provide the network-accessible services on behalf of the clients of the service provider.

In accordance with an embodiment, each host server (207, 212, 216) can host one or more virtual machine instances (208, 209, 213, 217) that are assigned to various users and/or clients of the service provider 215. Each virtual machine instance can host one or more applications (210, 211, 214, 218) on behalf of the owner of the application. For example, host server 207 can host multiple virtual machine instances (208, 209), wherein each machine instance is associated with a different user. This can create a shared resource environment, where a user's application is running on a set of resources that are shared with the application of another user. In this situation, it may be advantageous to provide various services and components that manage the virtual machine instances and keep the instances logically separated and independent from one another. In other embodiments, the host server may host a single virtual machine assigned to a single user in a single tenant execution environment.

In accordance with an embodiment, a user or client (202, 203, 204, 205) may provide a virtual machine image to the service provider 215 and this virtual machine image may be used to instantiate one or more virtual machine (VM) instances or virtual networks of multiple VM instances that can execute applications for the user. A virtual network can be created on any existing resource center of the service provider by transferring the virtual machine image to that resource center and instantiating all of the resources contained in the image.

In accordance with an embodiment, a virtual machine image is a virtual appliance which can be used to instantiate or create virtual machines on the resource center of the service provider. These virtual machines may be linked or connected to create a virtual network that can be used to perform the various services described herein. As demand for these services grows or shrinks, any number of virtual machines (e.g. compute instances, server instances, etc.) can be added to or removed from the virtual network. In various embodiments, the virtual private network enables a user to provision a private, isolated section of the service provider's network where the virtual machines can be instantiated. In accordance with an embodiment, the user may specify any network topology, including selection of internet protocol (IP) address range, creation of subnets, and configuration of route tables and network gateways.

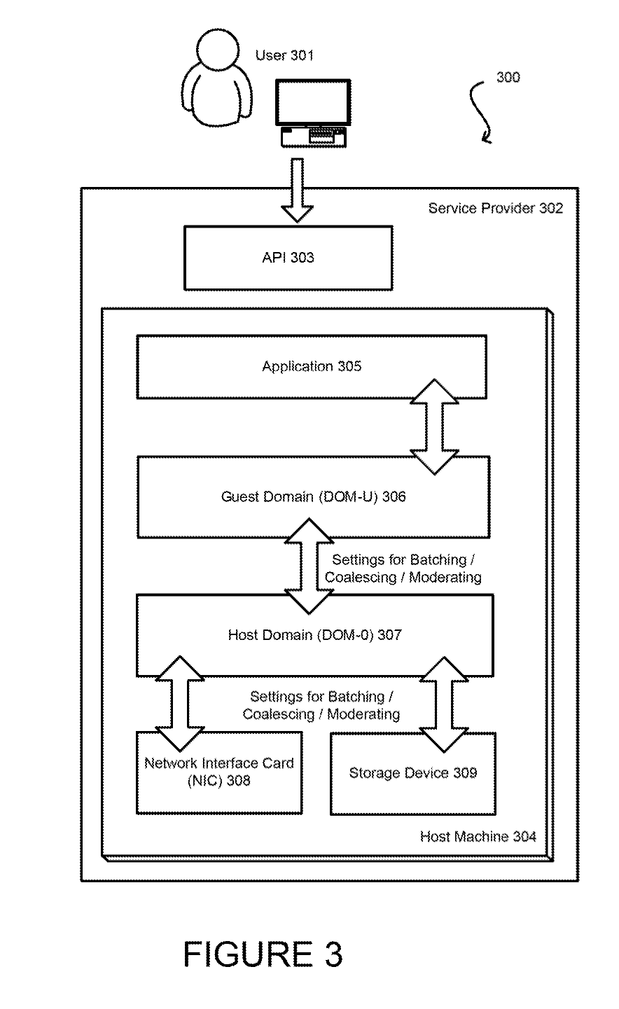

FIG. 3 illustrates an example 300 of a resource stack whose settings can be tuned by a user, in accordance with various embodiments.

In accordance with the illustrated embodiment, the host machine 304 provided by a service provider 302 may include a number of hardware devices 308, 309, a host domain (e.g. Dom-0) 307, one or more guest domains (e.g. Dom-Us) 306 that execute at least one application 305. The service provider provides an application programming interface 303 that enables a user 301 to specify to the host machine 304 a performance parameter, such as throughput, latency, CPU utilization, or the like. For example, the user may indicate that the performance of the stack should favor either (1) low latency with higher CPU utilization; or (2) higher throughput with lower CPU utilization. Based on the preference of the user, the hosting system can then dynamically adjust the settings of the underlying resource stack to favor the preferred performance parameter specified by the user. In various embodiments, tuning the settings may include adjusting various batching and moderating processes that are available on the hosting device 304, such as enabling/disabling interrupt coalescing, enabling/disabling segmentation offload, increasing or decreasing the size of a ring buffer used to share data between several resources, batching input/output (I/O) operations and the like.

In various embodiments, the settings may be adjusted at any level of the resource stack. For example, the system may enable or disable interrupt coalescing between the guest domain 306 and the host domain 307. Alternatively, the system may enable or disable interrupt coalescing between the host domain 307 and the actual hardware device, such as NIC 308 or SSD 309. Similarly, the system may enable the user to enable or disable segmentation offload, increase or decrease the size of a ring buffer used to share data between two or more resources in the stack, enable or disable the batching of various I/O operations and tune any other settings at any level of the resource stack. As yet another example, the system may modify one or more scheduling parameters in the host operating system (OS) or hypervisor running on the resource stack.

In various embodiments, the user may also specify performance parameters on a per-hardware resource, or specifically a per-CPU basis. For example, the user 301 may indicate via API 303 that CPU0 should be reserved for application processing and therefore indicate that this particular CPU should be tuned for lower CPU utilization. In that case, the system may tune the underlying settings to favor lower CPU usage, such as turning on interrupt coalescing for CPU0 and adjusting various other settings.

In accordance with at least one embodiment, the preferred performance parameter may be included as metadata upon requesting the virtual machine instance and the metadata may be used as a placement parameter to select a physical host server for the virtual machine instance. For example, if the user indicates that the instance should favor low latency, the system may select the host server that has been tuned for low latency and is potentially already hosting other instances/applications that wish to utilize low latency tuning. Similarly, if the user has indicated that the instance should favor high throughput, the system may place the instance onto a host server that has been pre-configured with settings for high throughput (e.g. enabled interrupt coalescing, etc.). It should be noted that the various embodiments described herein are not limited to virtual machine instances and can include compute nodes or any other entities capable of being hosted on the hardware of the service provider, such as a guest operating system having native (“bare metal”) access to the hardware resources.

In accordance with some embodiments, the system can dynamically analyze the user's 301 workload and automatically tune the resources according to the analysis. In some embodiments, this may involve gathering system resource utilization metrics or other metrics external to host servers which provide information about the resource requirements of the workload. In one embodiment, the system may perform network packet inspection or connection tracking analysis of the workload being performed by the user's application 305 in order to infer the user's requirements. For example, the system may determine, based at least in part on the analysis of the runtime information, whether the workload of the application comprises mostly request/response type of workload or mostly streaming of content. In one embodiment, TCP connection analysis can be utilized to determine, based on various patterns, whether the traffic processed by the application is mostly sporadic request/response traffic or long lasting streaming connections. In that case, if the system determines that the user's application is performing mostly request/response communication, it can favor latency. If the system determines that the user's application is performing mostly streaming communication, it can favor throughput. Alternatively, other resources in the system may be sampled, such as detecting CPU utilization during periods of networking to determine whether the CPU is typically being utilized simultaneously with the network resources (e.g. NIC 308). Based on this information, the system may select one type of setting for resources that utilize the CPU simultaneously with the network and another type of settings for resources that utilize the CPU at different times than the network in order to minimize the impact to the CPU.

In accordance with an embodiment, the system may periodically (e.g. every 5 minutes) reevaluate the workload and other runtime information of the application to readjust the settings according to more current traffic patterns of the application 303. The time interval for reevaluating the information can be made configurable by using a policy, configuration file or the like. In at least one embodiment, the performance tuning of various settings can be based at least in part on various network conditions, network substrate or other information about the underlying network resources, which is known by the service provider.

In accordance with at least some embodiments, the user 301 can work with the service provider 302 to analyze various execution metrics associated with its application 303. For example, the user may call into an API in the host domain and indicate to the system when to start and stop collecting runtime metrics for different resource configurations, as previously described. The system can analyze and compare the metrics of the various configurations, and determine the optimal settings for the resource stack in order to allow the application to execute more efficiently. For example, if the system determines based on the execution metrics that the application performs mainly streaming of content, the settings of the various resources may be tuned for high throughput. If the user's reported metrics indicate that the application is performing mostly request/response type of workload, the resource stack can be tuned for low latency instead.

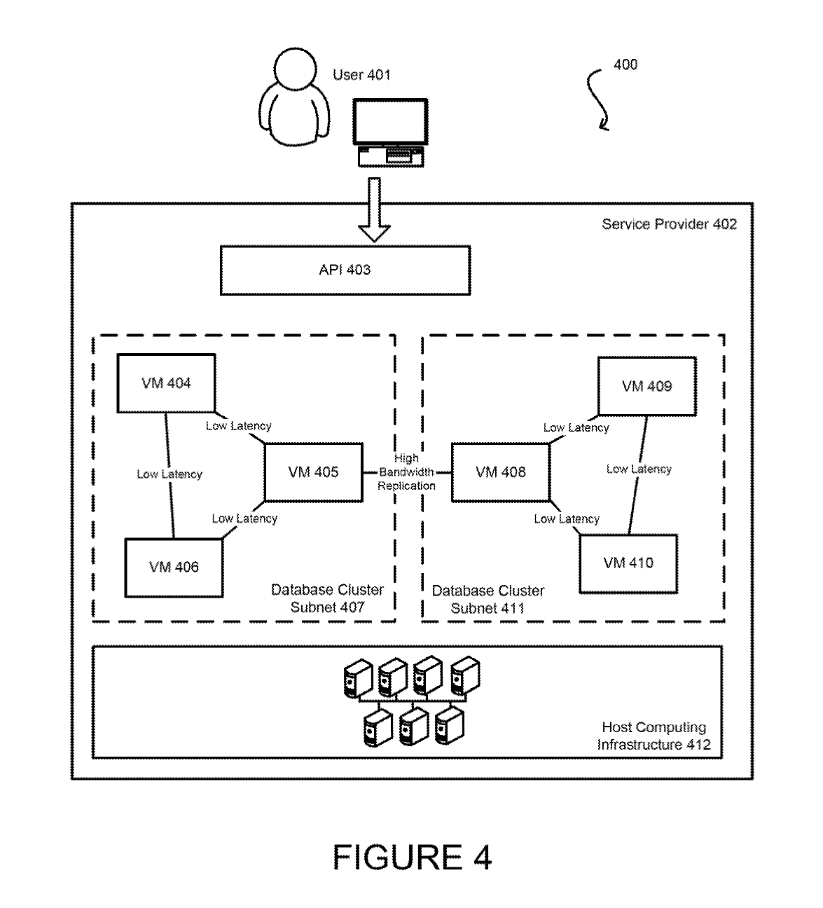

FIG. 4 is an illustration of an environment 400 where a user is enabled to create virtual networks with optimized connections in accordance with various embodiments.

In accordance with the illustrated embodiment, the service provider 402 can provide the host computing infrastructure 412 that enables a user 401 to create one or more virtual networks or sub-networks (subnets) (407, 411) or two or more virtual machine instances. In one embodiment, the user 401 may invoke an API 403 to specify the preferences for the connections between the various virtual machine nodes of the network or subnet. Based on the specified preferences, the system may determine the placement of the various virtual machine nodes onto the host computing devices that are tuned with the settings that are appropriate for the desired connections. Alternatively or in addition, the system may adjust the settings of the underlying host device that runs the virtual machine node to optimize it for the preferred connection.

In the example illustrated in FIG. 4, the user 401 can provide topology information for creating a database cluster subnet 407, comprised of three virtual machine nodes (404, 405, 406) and indicates to the service provider that the connections between virtual nodes of the subnet 407 should be tuned to favor low latency. In addition, user 401 creates a second database cluster 411 comprised of three other virtual machine instance nodes (408, 409, 410), wherein the connections between each of the nodes (408, 409, 410) is also tuned for low latency. The user may then specify that the data stored in subnet 407 should be periodically replicated to subnet 411 over a connection that is specifically tuned for high throughput. The system may then tune the settings of the various computing devices and other resources hosting the virtual machine nodes (404, 405, 406, 408, 409, 410) according to the topology information provided by the user 401. In one embodiment, the system models the topology information and determines placement for the various virtual machine nodes on host computing devices according to the desired performance parameter specified by the user. For example, the system may choose to place the low latency instances onto host servers that have been tuned for low latency or otherwise provide lower latency connectivity by design (e.g. logically “closer” together) and the like.

It should be noted that the particular topology shown in FIG. 4 is merely one example of the various virtual networks that can be created and that the various embodiments described throughout this disclosure are not limited to the particular topology shown.

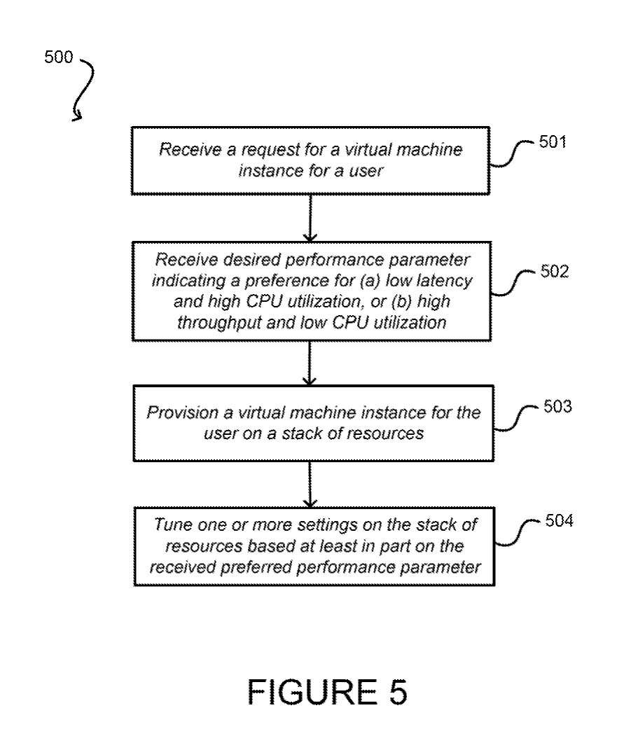

FIG. 5 illustrates an example process 500 for dynamic tuning of virtual resources, in accordance with various embodiments. Although this figure may depict functional operations in a particular sequence, the processes are not necessarily limited to the particular order or operations illustrated. One skilled in the art will appreciate that the various operations portrayed in this or other figures can be changed, rearranged, performed in parallel or adapted in various ways. Furthermore, it is to be understood that certain operations or sequences of operations can be added to or omitted from the process, without departing from the scope of the various embodiments. In addition, the process illustrations contained herein are intended to demonstrate an idea of the process flow to one of ordinary skill in the art, rather than specifying the actual sequences of code execution, which may be implemented as different flows or sequences, optimized for performance, or otherwise modified in various ways.

In operation 501, a user submits a request to a service provider, requesting a virtual machine instance to be created. The virtual machine instance may include an operating system that will be used to execute one or more applications on behalf of the user. In one embodiment, the request includes a virtual machine image that contains all of the necessary information to instantiate the virtual machine on a server of the service provider.

In operation 502, the user further specifies a desired performance parameter to be used with the virtual machine instance. For example, the user may indicate that the underlying resource stack that hosts the VM should favor high throughput with low CPU utilization. Alternatively, the user may indicate that the resource stack should favor low latency with higher CPU utilization. In various alternative embodiments, the user may specify other desired performance parameters or combination thereof.

In operation 503, the service provider provisions a virtual machine instance on a stack of resources. In accordance with an embodiment, the virtual machine instance can be provisioned by deploying a guest operating system on a host computing device that resides in the resource center of the service provider. Once provisioned, the guest operating system can be used to execute the application provided by the user. In some embodiments, the choice of host computing device may be based at least in part on the performance parameters specified by the user in 502.

In operation 504, the service provider tunes one or more settings on the resource stack based at least in part on the performance parameter indicated by the user. For example, if the user indicated that the system should favor low latency, the settings can be tuned to disable interrupt coalescing and segmentation offloading throughout the various resources in the stack. Alternatively, if the user indicates that the system should favor high throughput, the settings may be tuned to enable interrupt coalescing and segmentation offload.

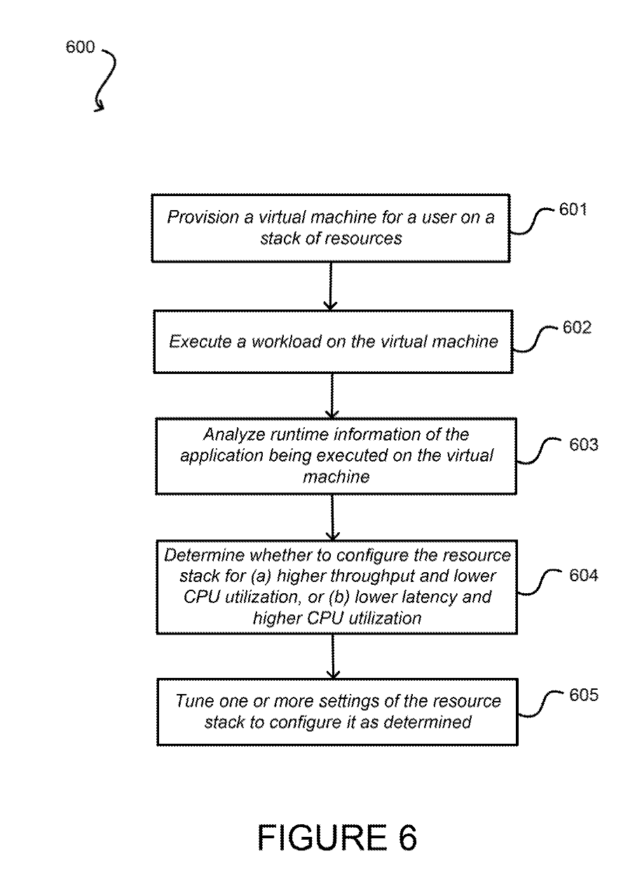

FIG. 6 illustrates an example process 600 for dynamically tuning the settings of the virtual resource stack based on gathered runtime information, in accordance with various embodiments. In operation 601, the service provider provisions a virtual machine for a user on a stack of resources, as previously described. In operation 602, the virtual machine instance is used to execute a workload for the user. In some embodiments, the workload may comprise an application deployed and running on the virtual machine. For example, the application may stream media content to one or more viewers, perform data computation, or perform any other activity. In other embodiments, the workload can include any other functionality executing on the virtual machine, such as kernel-level components, or a combination of user space and kernel components.

In operation 603, the system analyzes runtime information of the workload being executed on the virtual machine instance. For example, the system may perform network packet inspection and/or TCP connection tracking to gather information about the workload of the application. In operation 604, the system determines whether to configure the resource stack for (a) higher throughput and low CPU utilization or (b) lower latency and higher CPU utilization. In accordance with an embodiment, this determination is based at least in part on the analysis of the runtime information. For example, if the system determines based on the network packet inspection and connection tracking, that the workload is performing streaming operations over a high bandwidth connection during the majority of the time, the system may choose to configure the resource stack for high throughput.

In operation 605, the system automatically tunes one or more settings of the resource stack to favor either (a) higher throughput or (b) low latency, as determined in operation 604. For example, if the system chooses to configure the settings for low latency, it may disable all batching and moderating of various operations throughout the various levels of the resource stack, including but not limited to interrupt coalescing, segmentation offloading, I/O batching and the like.

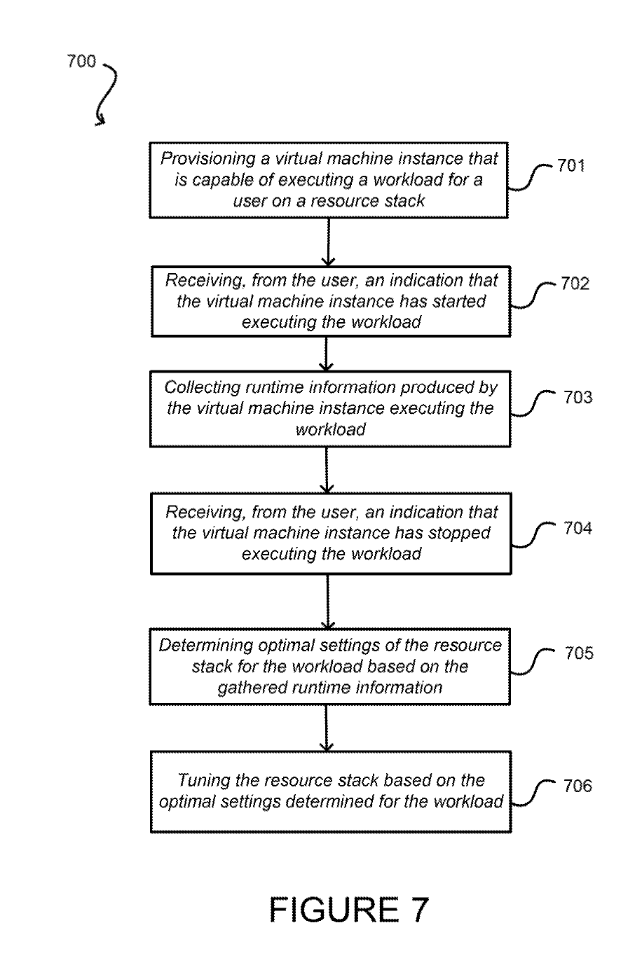

FIG. 7 illustrates an example process 700 for dynamically tuning the resource stack based at least in part on the execution metrics reported by a user, in accordance with various embodiments. In operation 701, the service provider provisions a virtual machine instance that is capable of executing a workload for a user on a resource stack, as previously described In operation 702, the user can indicate (e.g. by using an API or other service) that the virtual machine instance has started executing the workload (e.g. running an application). Once the indication is received, the system can begin to gather runtime information produced by the execution of the workload, as shown in operation 703. For example, the system can start connection tracking, deep packed inspection and the like. In operation 704, the user can submit an indication that the virtual machine instance has stopped processing the workload. In operation 705, the system analyzes the collected runtime execution metrics and determines the optimal settings for the resource stack in light of the reported data. In operation 706, the system tunes the settings of the resource stack based on the analyzed metrics. For example, the system may analyze the reported data and determine that the workload performs request/response workload and accordingly tune the resources stack to favor low latency.

In some embodiments, the system may allow a user to iterate through a plurality of different configurations of the resource stack before determining an optimal tuning of the stack. For example, the user can select a first configuration and run the workload on the virtual machine using the first configuration, wherein the system gathers runtime execution metrics produced by the resource stack. The user may then select a second configuration and run the workload on the virtual machine using the second configuration, where the system gathers runtime information for the second configuration. The system (or the user) may then compare the different sets of execution metrics in order to select a preferred configuration for the resource stack. Similarly, more than two configurations can be utilized in this manner, as will be evident to one of ordinary skill in the art.

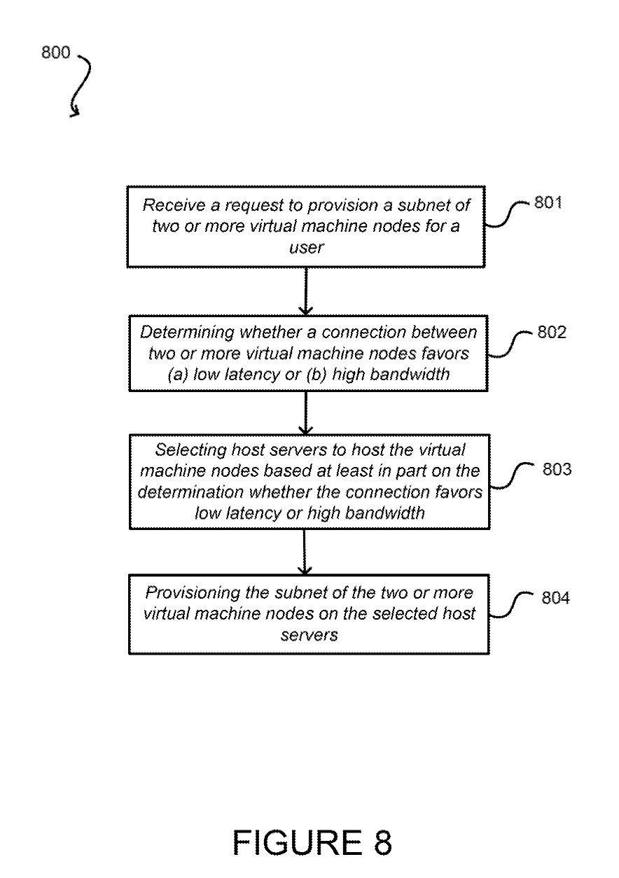

FIG. 8 illustrates an example process 800 for creating a virtual network with connections between virtual nodes that are optimized for a preferred performance parameter, in accordance with various embodiments. In operation 801, the system receives a request from a user to provision a virtual network or subnet of two or more virtual machine nodes for the user, for example which might share processing of a common workload or operation. The request may provide topology information, connectivity information, as well as various other data associated with the virtual network. In operation 802, the system can determine whether at least one connection between two or more virtual nodes favors either low latency, high bandwidth or other performance parameters, as described throughout this disclosure. In one embodiment, the system can make the determination based on a performance parameter indicated by the user using the API. In another embodiment, the system can make the determination based at least in part on the topology information and connectivity information for the virtual network or subnet.

In operation 803, the system selects one or more host servers to host the virtual machine nodes of the virtual network. In accordance with an embodiment, the host servers can be selected based at least in part on the determination of whether the connection should be a low latency connection or a high bandwidth connection. For example, if the system determines that the connection between two virtual nodes should be a low latency connection, the system may select two host servers whose settings have been tuned for low latency or are otherwise in close logical proximity (i.e. there are “fewer network hops” between them), as previously described. Similarly, if the connection is a high bandwidth connection, the system may select the host servers that have been tuned for high throughput. In operation 804, the virtual network or subnet of VM nodes is provisioned on the selected host servers.

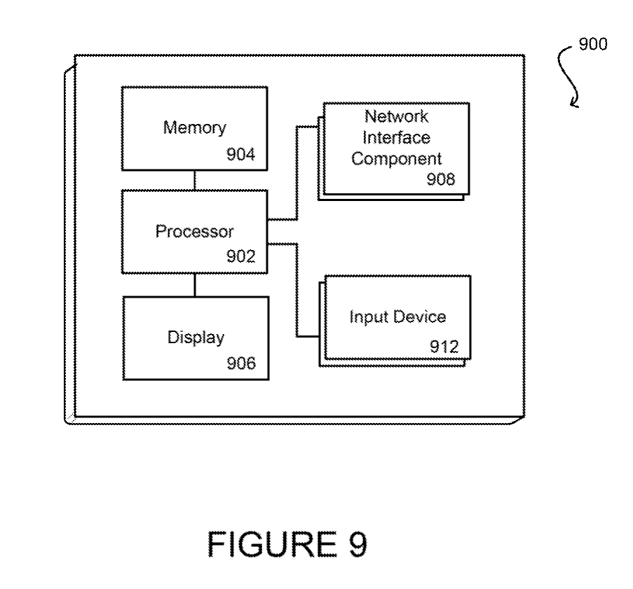

FIG. 9 illustrates a logical arrangement of a set of general components of an example computing device 900. In this example, the device includes a processor 902 for executing instructions that can be stored in a memory device or element 904. As would be apparent to one of ordinary skill in the art, the device can include many types of memory, data storage, or non-transitory computer-readable storage media, such as a first data storage for program instructions for execution by the processor 902, a separate storage for images or data, a removable memory for sharing information with other devices, etc. The device typically will include some type of display element 906, such as a touch screen or liquid crystal display (LCD), although devices such as portable media players might convey information via other means, such as through audio speakers. As discussed, the device in many embodiments will include at least one input element 908 able to receive conventional input from a user. This conventional input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device. In some embodiments, the computing device 900 of FIG. 9 can include one or more network interface elements 508 for communicating over various networks, such as a Wi-Fi, Bluetooth, RF, wired, or wireless communication systems. The device in many embodiments can communicate with a network, such as the Internet, and may be able to communicate with other such devices.

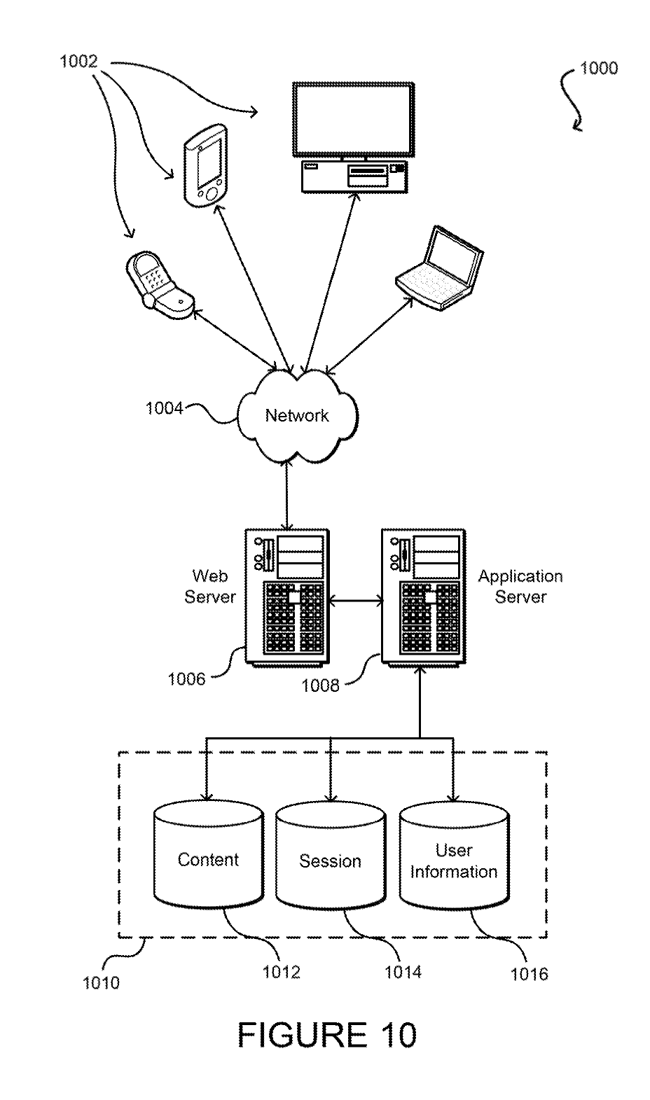

As discussed, different approaches can be implemented in various environments in accordance with the described embodiments. For example, FIG. 10 illustrates an example of an environment 1000 for implementing aspects in accordance with various embodiments. As will be appreciated, although a Web-based environment is used for purposes of explanation, different environments may be used, as appropriate, to implement various embodiments. The system includes an electronic client device 1002, which can include any appropriate device operable to send and receive requests, messages or information over an appropriate network 1004 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 1006 for receiving requests and serving content in response thereto, although for other networks an alternative device serving a similar purpose could be used, as would be apparent to one of ordinary skill in the art.

The illustrative environment includes at least one application server 1008 and a data store 1010. It should be understood that there can be several application servers, layers or other elements, processes or components, which may be chained or otherwise configured, which can interact to perform tasks such as obtaining data from an appropriate data store. As used herein the term “data store” refers to any device or combination of devices capable of storing, accessing and retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server in the form of HTML, XML or another appropriate structured language in this example. The handling of all requests and responses, as well as the delivery of content between the client device 1002 and the application server 1008, can be handled by the Web server 1006. It should be understood that the Web and application servers are not required and are merely example components, as structured code discussed herein can be executed on any appropriate device or host machine as discussed elsewhere herein.

The data store 1010 can include several separate data tables, databases or other data storage mechanisms and media for storing data relating to a particular aspect. For example, the data store illustrated includes mechanisms for storing production data 1012 and user information 1016, which can be used to serve content for the production side. The data store also is shown to include a mechanism for storing log or session data 1014. It should be understood that there can be many other aspects that may need to be stored in the data store, such as page image information and access rights information, which can be stored in any of the above listed mechanisms as appropriate or in additional mechanisms in the data store 1010. The data store 1010 is operable, through logic associated therewith, to receive instructions from the application server 1008 and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device 1002. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 10. Thus, the depiction of the system 1000 in FIG. 10 should be taken as being illustrative in nature and not limiting to the scope of the disclosure.

Various embodiments discussed or suggested herein can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A computer implemented method comprising:
under the control of one or more computer systems configured with executable instructions,
provisioning a compute node for a user on a resource stack;
executing a workload on the compute node;
analyzing runtime information associated with the workload being executed on the compute node;
determining, based at least in part on analyzing the runtime information, whether to configure the resource stack for either higher network throughput or lower network latency, and
modifying one or more settings for at least one resource in the resource stack to configure the resource stack for either higher network throughput or lower network latency as determined based at least in part on the analyzed runtime information.

2. The method of claim 1, wherein the one or more settings include at least one of:
enabling or disabling interrupt coalescing for the at least one resource;
enabling or disabling segmentation offload for the at least one resource;
modifying one or more scheduling parameters in an operating system or a hypervisor of the resource stack;
increasing or decreasing a size of a ring buffer associated with the at least one resource; or
enabling or disabling one or more batching operations associated with the at least one resource.

3. The method of claim 1, wherein the one or more settings include tuning a hypervisor to enable or disable interrupt coalescing between a host domain and a hardware device operating of the resource stack.

4. The method of claim 1, wherein analyzing the runtime information further includes:
performing at least one of network packet inspection or connection tracking for the workload executing on the compute node.

5. The method of claim 1, wherein determining whether to configure the resource stack for higher throughput or lower latency further includes:
determining that the workload is performing an amount of request/response communications higher than a threshold; and
modifying the one or more settings to configure the resource stack for lower latency in response to the determination that the workload is performing the amount of request/response communications.

6. The method of claim 1, wherein determining whether to configure the resource stack for higher throughput or lower latency further includes:
determining that the workload is performing an amount of streaming communications higher than a threshold; and
modifying the one or more settings to configure the resource stack for higher throughput in response to the determination that the workload is performing the amount of streaming communications.

7. The method of claim 1, further comprising:
receiving an indication from the user that the compute node has started processing the workload; and
receiving an indication from the user that the compute node has finished processing the workload;
wherein runtime information produced by the compute node executing the workload is collected and stored for analysis.

8. The method of claim 1, further comprising:
receiving a selection of a first configuration for the resource stack;
collecting a first set of runtime information associated with the first configuration;
receiving a selection of a second configuration for the resource stack;
collecting a second set of runtime information associated with the second configuration; and
comparing the first set of runtime information and the second set of runtime information to select one of the first configuration or the second configuration for the resource stack.

9. A non-transitory computer readable storage medium storing one or more sequences of instructions executable by one or more processors to perform a set of operations comprising:
provisioning a compute node for a user on a resource stack;
executing a workload on the compute node;
analyzing runtime information associated with the workload being executed on the compute node; and
determining, based at least in part on the analyzing the information, whether to configure the resource stack for either higher throughput or lower latency.

10. The non-transitory computer readable storage medium of claim 9, further comprising instructions to perform an operation of:
modifying one or more settings for at least one resource in the resource stack to configure the resource stack for either higher throughput or lower latency.

11. The non-transitory computer readable storage medium of claim 9, wherein analyzing the runtime information further includes:
performing at least one of network packet inspection or connection tracking for the workload executing on the compute node.

12. The non-transitory computer readable storage medium of claim 9, wherein determining whether to configure the resource stack for higher throughput or lower latency further includes:
determining that the workload is performing an amount of request/response communications higher than a threshold; and
modifying the one or more settings to configure the resource stack for lower latency in response to the determination that the workload is performing the amount of request/response communications.

13. The non-transitory computer readable storage medium of claim 9, wherein determining whether to configure the resource stack for higher throughput or lower latency further includes:
determining that the workload is performing an amount of streaming communications higher than a threshold; and
modifying the one or more settings to configure the resource stack for higher throughput in response to the determination that the workload is performing the amount of streaming communications.

14. A computer implemented method for tuning performance settings in a virtualized computing environment, said method comprising:
receiving a request for a virtual machine instance from a user;
provisioning the virtual machine instance on a resource stack;
receiving, from the user of the virtual machine instance, information indicating a performance parameter for at least one resource of the resource stack, the performance parameter indicating a threshold for either high throughput or low latency; and
tuning one of more settings of the at least one resource in the resource stack based on the information indicating the performance parameter.

15. The computer implemented method of claim 14, wherein the one or more settings include at least one of:
enabling or disabling interrupt coalescing for the at least one resource;
enabling or disabling segmentation offload for the at least one resource;
modifying one or more scheduling parameters in an operating system or a hypervisor of the resource stack;
increasing or decreasing a size of a ring buffer associated with the at least one resource; or
enabling or disabling one or more batching operations associated with the at least one resource.

16. The method of claim 14, further comprising:
analyzing runtime information associated with the resource stack produced by executing one or more workloads on the virtual machine instance; and
determining values for the one or more settings based at least in part on analysis of the runtime information.

17. The method of claim 14, wherein receiving, from the user of the virtual machine instance, information indicating the performance parameter for the at least one resource of the resource stack further includes:
receiving an indication from the user that the virtual machine instance has started processing a workload; and
receiving an indication from the user that the virtual machine instance has finished processing the workload;
wherein runtime information produced by the virtual machine instance executing the workload is collected and stored for analysis.

18. The method of claim 14, wherein tuning one of more settings of the at least one resource in the resource stack based on the information indicating the performance parameter, further includes:
receiving a selection of a first configuration for the resource stack;
collecting a first set of runtime information associated with the first configuration;
receiving a selection of a second configuration for the resource stack;
collecting a second set of runtime information associated with the second configuration; and
comparing the first set of runtime information and the second set of runtime information to select one of the first configuration or the second configuration for the resource stack.

19. The method of claim 14, wherein tuning the one or more settings includes tuning a hypervisor to enable or disable interrupt coalescing between a host domain and a hardware device operating of the resource stack.

20. The method of claim 14, wherein the performance parameter further indicates a threshold for central processing unit utilization.
